(19) United States
(12) Patent Application Publication
(10) Pub. No.: US 2008/0037241 A1
(43) Pub. Date: Feb. 14, 2008

(54) Light fixture

(75) Inventor: Jens Von Der Brelie, Frankfurt (DE)

Correspondence Address: K.F. ROSS P.C., 5683 RIVERDALE AVENUE, SUITE 203 BOX 900, BRONX, NY, 10471-0900, US

(73) Assignee: ERCO Leuchten GmbH

(21) Appl. No.: 11/529,705

(22) Filed: Sep. 28, 2006

(30) Foreign Application Priority Data
Apr. 21, 2006 (DE) 202006006632.2
Jul. 27, 2006 (DE) 102006035.557.1

(51) Int. Cl. F21V 33/00; F21S 8/00

(52) U.S. Cl. 362/145; 362/234

(57) ABSTRACT

The invention illustrates and describes, among other things, a light fixture (10, 10a, 10b, 10c, 10d, 10e, 10f, 10g, 10h, and 10i) to be attached to a building surface or part of a building surface, comprising a connection for a signal line (11) for connecting the light fixture to a controller (12) and comprising a memory (15) to which an identifier allowing the identification of the light fixture is written, which identifier can be transmitted via the signal line.

The special characteristic includes, among other things, that the light fixture comprises a transmitter (16, 16a) that can be used to wirelessly transmit signals to a position-determining unit (17) for determining the installation location of the light fixture.

The invention relates to a light fixture according to the preamble of claim 1.

A light fixture is known that is permanently installed, for example in or on a building ceiling or building wall. The light fixture, however, may also be used outside a building, for example, as a street lamp. Furthermore, the invention also relates to light fixtures that are permanently mounted on power rails or similar fastening devices. The light fixture according to the invention serves for the illumination and lighting of building areas or outside areas or of objects, such as works of art as well as alternatively or simultaneously the creation of decorative or ambience lighting. Finally, the invention also relates to information or signal lamps of the like.

It is already known to combine a plurality of light fixtures into a lamp control system. The important aspect is that the light fixtures can be selected individually by a controller in order to create the desired light effects, also referred to overall as light scenes.

Particularly when the lamp control system comprises a plurality of light fixtures, at least up to several hundred light fixtures or even more, the installation expenses are significant. It is known from the published German patent application DE 10 2005 009 228 A1 to provide each light fixture with a unique identifier, the contents of which application are hereby included in the content of the present patent application by reference. This identifier allows a clear identification of the light fixture by the controller that is connected to the light fixture via a signal line. The identifier, typically a in a chassis or serial number, may also be replaced after installation by the controller with a shorter operating address. It is important that the identifier allows the differentiation of all light fixtures connected to the controller from each other.

When the light fixtures installed on-site are connected to the controller via the signal line, queries regarding the identifier can be carried out via the common signal line and each light fixture can be addressed individually, for example in order to turn it on or off or to generate a certain dimmed level or a certain color.

Following the installation of the light fixtures at the point of use, however, it is still a problem to transmit information to the controller about the installation location, meaning about the installed position of the light fixture in the room.

After all, the controller is not able to obtain information as to where the individual light fixtures are located simply from the fact that the individual light fixtures can be differentiated from each other. For example, the controller does not know that a light fixture with a certain identifier is located in a certain room. This position information, however, is important for the controller in order to comfortably plan, for example, a light scene when an operator at the controller would like to generate a specific light scene or when software is supposed to address the light fixtures in order to create the light scene.

For the transmission of position data, it is cumbersomely required that at least several persons manually record the installed light fixtures and their installation locations. When, for example, a person is in room x and realizes that light fixture z is installed in a certain installation location y, the person, for example via telephone, has to contact another person at, for example, a very remote controller. The operator at the controller now has to activate the light fixture z installed in the installation location y so that it flashes. This is not simple, considering that, for example, several hundred light fixtures are connected to the controller. Typically, all light fixtures are addressed successively and then flash, for example, successively. When the operator at the installation location y of the light fixture detects that the light fixture z to be observed flashes, appropriate feedback can be provided via telephone to the operator at the controller, who then manually enters the position information in the controller.

It is therefore the object of the invention to further develop a light fixture, which is already known, according to the preamble of claim 1 such that it allows simplified installation and/or setting up.

The invention achieves this object with the characteristics of claim 1, particularly with those of the characterizing part, and is accordingly characterized in that the light fixture comprises a transmitter that can be used to transmit signals wirelessly to a position-determining unit for determining the installation location of the light fixture.

The principle of the invention therefore essentially is to automate the process for detecting the position of the installed light fixture. According to the invention, a position-determining unit is provided that is provided on the building or in proximity to the light fixture particularly in a permanent manner. The position-determining unit can be formed, for example, by three WLAN modules provided in the building. The light fixture according to the invention comprises, for example, a transmitter that can emit WLAN signals. The signals include the identifier written to the memory or at any rate information that can be clearly related to the identifier. Based on the transmitted signals, the position-determining unit is able to detect the installation location of the transmitter and therefore the installation location of the light fixture. For this, for example, the signal field strengths received from the three WLAN modules of the position-determining unit are determined. It is also possible to detect directions along which the signals propagate. As a result, the exact location of the transmitter can be clearly detected.

Conventional positioning methods operate, for example, based on the measurement of signal strengths, meaning with measured signal field strengths. Alternative methods operate based on the measurement of propagation differences. Finally, also methods are available that measure the angle of the signal path direction. The different methods for determining the position of a transmitter with the help of a position-determining unit comprising WLAN modules are presumed known from the related art.

The exact manner of determining the installation location of the light fixture is not important for the principle according to the invention. Arbitrary radio signals or other electromagnetic signals may be used. WLAN signals, meaning signals, for example, in the range of a 5 GHz band, are also particularly suited to penetrate building walls or building ceilings. This way, using only a single position-determining unit in a building, meaning only three permanently installed WLAN modules, for example, the positions of a plurality of light fixtures installed in the building can be determined. The ranges of commercially available position-determining units can extend up to several hundred meters in a building and are therefore suited to detect all light fixtures installed in a building.

Furthermore, it is conceivable to use, for example, satellite-based position-determining units, such as GPS or the future Galileo system.

The position-determining unit is connected to the controller and can transmit the detected information about the installation location of the light fixture to the controller. It should be noted that in fact the installation location of the transmitter is detected. However, since the transmitter is provided close to the light fixture, the information regarding the installation location of the transmitter roughly corresponds to the information regarding the installation location of the light fixture.

The position-determining unit transmits information to the controller about the installation location of the light fixture by stating the identifier or information that clearly relates to the identifier. The controller can read the identifier from the memory of the light fixture via the signal line, or at least it can address the light fixture individually by transmitting the identifier obtained from the position-determining unit. As a result, the controller can combine and process the information regarding the installation location of the light fixture and the addressability of the light fixture via the signal line.

Therefore, after carrying out the installation routine, the controller is in a position to address the light fixture individually, knowing its installation location. Following the installation therefore optimized planning of light scenes and a smooth subsequent operation of the lamp control system is possible. It should be noted that in a lamp control system a plurality of light fixtures must be controlled that are all connected to a common signal line and that are each assigned different identifiers. The position-determining unit can successively detect the different installation locations of the individual light fixtures and transmit information about all installation locations to the controller.

The light fixture according to the invention therefore allows simpler setting up or installation of a control system for light fixtures.

The invention achieves the object described above according to a second aspect of the invention also with a light fixture with the characteristics of claim 2, particularly those of the characterizing part, and is therefore characterized in that an accessory for the light fixture mounted close to the light fixture, for example control gear, comprises a transmitter that can be used for the wireless transmission of signals to a position-determining unit for determining the installation location.

This invention is best understood based on the explanations provided for claim 1. Contrary to claim 1, the transmitter is provided on an accessory for the light fixture. The accessory may be, for example, control gear, meaning an electrical controller, for the light fixture. The control gear is provided close to the light fixture so that the identification of the installation location of the transmitter at the same time offers information about the installation location of the light fixture. The accessory, however, can also be part of the light fixture. It may be provided in a common light fixture housing that also comprises light fixture components such as the light sources, reflectors, base etc. Alternatively, the accessory may comprise a housing that is separate from the light fixture housing and it can be connected, for example, via an electrical plug connection or via a cable to the actual housing.

From a design point of view, this invention allows a particularly advantageous configuration since the control gear for the light fixtures may comprise memories in which the identifier allowing the identification of the light fixture is written. When the control gear also comprises the transmitter that advantageously also has a memory with the identifier, it is particularly simple to produce the light fixture and/or the accessory according to the invention with little additional expense.

The invention furthermore relates to a power rail according to the preamble of claim 3.

Power rails according to the preamble of claim 3 are known. The published German patent application of the applicant mentioned above describes light fixtures with a memory, to which an identifier allowing the identification of the light fixture is written. Light fixtures of this type are configured, for example, like radiators that can be used on any conventional power rail with the help of a power rail adapter or similar fastening element. The known power rail, as described for example also in DE 10 2005 019 632 A1 by the applicant, allows the transmission of an operating voltage to the light fixture as well as the transmission of signals. At least two conductors of the power rail therefore provide a signal line or a signal line section. The power rail itself has a connection for connecting the conductor paths used as signal conductors to the signal line and thus connect the light fixtures to the controller.

Starting from a power rail according to the preamble of claim 3, it is the object of the invention to simplify the installation of a lamp control system with power rails according to the preamble of claim 3.

The invention achieves this object with the characteristics of claim 3, particularly with those of the characterizing part, and is accordingly characterized in that the power rail comprises a transmitter that can be used to transmit signals wirelessly to a position-determining unit to detect the installation location of the power rail and/or to detect the installation orientation of the power rail and/or to determine the installation location of the light fixture.

The principle of the invention is therefore substantially to provide a transmitter on the power rail. The transmitter may be provided, for example, in the region of a power rail power supply unit, meaning particularly in the region of an end cap or a component provided at the end of the power rail. The power rail power supply unit is the component that connects the power rail to the operating voltage supply line and/or to a signal line.

A power rail as defined by the present patent application is any fastening device for a light fixture or for several light fixtures with a seat groove in which a plug-in part of the light fixture or a power rail adapter can be inserted so as to connect the light fixture mechanically and electrically as well as from a data technology point of view to the power rail.

In the case of a long straight power rail, it may suffice to attach a single transmitter on one of the two ends of the power rail. If it is clear in advance, for example, what the orientation of the power rail must be and if the controller is able to clearly detect the orientation of the power rail or if the controller knows the predefined orientation of the power rail, it is no longer required that the power rail receives information about the position of the two ends of the power rail, but instead it suffices if the controller only receives information about the position of one end of the power rail, because this produces a clear installation geometry of the permanently installed power rail.

If, for example, several power rails are connected to each other, for example in a substantially L-shaped configuration or a T-shaped or also cross-shaped configuration or in a series configuration of several power rails next to each other, it is recommended to assign at least one separate transmitter to each power rail. Each power rail is preferably associated with a pair of transmitters, so that the positions of the two end points of the power rail can be detected.

The principle of detecting the position of the transmitter works analogously to the principles discussed with respect to claims 1 and 2. Therefore, reference is made to the above explanations. Again, in fact the installation location of the transmitter is detected, however it can be equated in most applications with the installation location of the power rail or with the installation location of a certain point of the power rail. In most cases it suffices to determine the installation orientation of the power rail, it will not be important to determine the installation location of the power rail, but the orientation of the power rail in the installed position. In this case it will suffice if the transmitter transmits signals to the position-determining unit that allow the determination of the installation orientation.

The power rail may comprise a separate memory, allowing the identification of the power rail in the lamp control system. In this case, the power rail will also have a separate power rail identifier, and the transmitter can wirelessly transmit this power rail identifier to the position-determining unit, so that the position-determining unit can detect position information regarding the transmitter and forward it to the controller.

Alternatively, the power rail may also query the identifiers of the light fixtures connected to the power rail, so that the transmitter subsequently can transmit one or several of the identifiers queried from the light fixtures as signals to the position-determining unit.

It is not important what identifier is transmitted with the signals from the transmitter to the position-determining unit. For the invention, however, it is essential that the controller receive the position of either the light fixtures connected to the power rail or of the power rail or at least the orientation of the power rail.

Typically, several light fixtures are provided on a power rail, and each light fixture has a respective identifier. In case only one light fixture is provided on a power rail, the controller recognizes the installation location of the light fixture also from the determined installed position of the power rail.

If several light fixtures are associated with the power rail, it may be of interest to provide the controller with position information about every light fixture that is connected to the power rail. In this case, as described above with respect to claims 1 and 2, each individual light fixture may be provided with a transmitter. Alternatively, however, it also suffices to associate the power rail with one transmitter, or in other embodiments with two transmitters that in turn detect the position of the light fixtures on the power rail. For this, it is conceivable, for example, that the transmitter can also emit signals, to which the individual light fixtures connected to the power rail reply. The signal responses of the individual light fixtures may cause propagation differences, for example that can be detected by a measuring device of the transmitter on the power rail. This way, the transmitter can determine the sequence in which the light fixtures are mounted on the power rail. Insofar it is important that the radiators are easy to remove from the power rail and move to a different point of use. By using the possibility according to the invention of determining the relative positions of the light fixtures on the power rail, as has been described above, advantageously it can be determined quickly and easily what light fixtures are located on the power rail and in what relative positions, even after an radiator has been moved.

The information regarding the relative positions of the individual light fixtures on the power rail recorded by the transmitter can be transmitted by the transmitter to the position-determining unit along with the signals. Alternatively, the information regarding the relative positions of the light fixtures connected to the power rail can also be transmitted to the controller via the signal line.

According to an advantageous embodiment of the invention, the positioning comprises at least two, preferably at least three, preferably stationary transceivers so as to form reference points.

The term transceiver as defined by the present patent application means that the position-determining unit is in a position to detect the signals emitted by the transmitter of the light fixture or the accessory or the power rail. Signal identification here also includes the possibility of detecting the position of the transmitter. It is not important whether the transmitter transmits semicontinuously until an installation process has been concluded, or whether the position-determining unit emits signals and triggers and receives response signals from the transmitter this way.

It is important that the position-determining unit provide spatial reference points that allow a relation to be established between the position of the transmitter and the three reference points. Following installation, the position-determining unit can optionally also be removed. It is preferred, however, if the position-determining unit remains stationary at the point of use, for example permanently installed in the building, in order to be able to carry out a new position-sensing process for all light fixtures in the event a change is made to the installation, for example by removing light fixtures from a power rail and reattaching light fixtures to a different power rail or in a different location on the power rail. Position sensing of this type for all light fixtures could also be carried out at regular intervals, for example once a month, if the intent is to determine in larger lamp control systems, for example in museums, where each light fixture is currently located. This can be of interest in large museums, for example for temporary exhibitions, when light fixtures are frequently moved.

The position-determining unit may be mounted on a building surface or on part of a building surface. If the light fixtures or the power rail or the accessories for the light fixtures are mounted outdoors, the position-determining unit can of course also be provided outdoors.

If the position-determining unit is only required for the duration of the installation, it is also possible to provide a mobile position-determining unit. For example, three transceivers may be installed for a certain period and removed following the installation of the light fixtures.

Particularly if the position-determining unit is supposed to remain permanently installed, it may be part of a light fixture or part of an accessory for a light fixture or part of a power rail. If the position-determining unit uses WLAN modules, corresponding modules can be assembled, for example, directly in the light fixture, in an accessory for the light fixture or in a power rail or a power rail power supply unit. The position-determining units or the components thereof can also be mounted in power rails, for example.

The position-determining unit preferably comprises a receiver for the signals from the transmitter. The receiver allows the identification of signals transmitted by the transmitter, optionally also the storage or evaluation thereof. The position-determining unit itself may be in a position to detect the installation location of the transmitter or the installation location of the light fixture or the installation location or installation orientation of the power rail or of an accessory from the received signals. Alternatively, however, the position-determining unit may also transmit the received information to the controller, the controller computing the installation location or the installation orientation from the received information.

Therefore, according to an advantageous embodiment of the invention, the position-determining unit comprises a processor unit that allows the position of the transmitter, the light fixture, the accessory or the power rail to be determined from the received signals. Alternatively, the controller comprises a corresponding processor unit.

The position-determining unit, preferably the processor unit, may furthermore be associated with a measuring unit that is used to measure the field strengths of the signals and/or propagation differences of the signals and/or propagation directions of the signals.

As a result, the position-determining unit or the processor unit can determine the relative position of the transmitter in relation to the reference points provided by the position-determining unit. If the position-determining unit knows its own absolute position, or if the control unit knows the absolute positions of the corresponding reference points, this information can be used to compute the absolute position of the transmitter and therefore the installation location of the light fixture, the accessory or the power rail.

According to an advantageous embodiment of the invention, the position-determining unit detects the installation location of the light fixture or the accessory. Alternatively, the installation location can be detected by the controller.

According to a further advantageous embodiment of the invention, the position-determining unit is connected to the controller. The connection can be established via a radio link or a further signal line. It is important that the readings determined by the position-determining unit and/or the computed position data, including the simultaneously transmitted identifier of the individual light fixture, is transmitted to the controller.

According to a further advantageous embodiment of the invention, the identifier can be transmitted to the position-determining unit together with the signals. The identifier is then transmitted from the light fixture via the signal line to the controller on the one hand and via a second transmission path from the light fixture, in fact from the transmitter, to the position-determining unit on the other hand. The position-determining unit then in turn transmits the identifier to the controller. The controller can then combine these two pieces of information.

According to a further advantageous embodiment of the invention, the identifier can be transmitted from the position-determining unit to the controller.

To the extent that the identifier to be transmitted is addressed in this patent application, it is important that the term identifier comprises all the codes and descriptions that allow a unique identifier of the light fixture. For example, the transmitter can also transmit appropriate information to the position-determining unit along with the signals instead of the identifier, which information can be clearly related to the identifier. This information, as defined by the present application, is also considered part of the term “identifier.”

According to an advantageous embodiment of the invention, the identifier can be read from the memory and transmitted to the controller via the signal line. As a result, the controller in effect receives the identifier via two different transmission paths. Alternatively, however, the controller can also transmit the identifier it receives from the position-determining unit to the light fixture, the light fixture or a comparable device associated with the memory of the light fixture examining whether based on the content of the identifier the addressed light fixture is affected by the signal received from the controller or not.

According to the preamble of claim 18, the invention relates to a system for controlling and/or installing a plurality of light fixtures. The light fixtures are connected to a controller via a signal line. At least one of the light fixtures has a memory, to which an identifier allowing the clear identification of the light fixture is written. Preferably, each light fixture connected to the signal line has it own unique identifier. The light fixtures are all connected to the controller via the signal line. The identifier can be transmitted via the signal line, preferably it is transmitted to the controller from the individual light fixture.

It is the object of the invention to further develop a system according to the preamble of claim 18 such that simplified setting up is possible.

The invention achieves this object with the characteristics of claim 16, particularly with those of the characterizing part, and is accordingly characterized in that the light fixture is associated with a transmitter that can be used to transmit signals wirelessly to a position-determining unit for determining the installation location of the light fixture.

The principle of the invention is best understood by analogy to the description of the invention according to claims 1 to 17.

The system according to the invention can be put in service particularly easily, requiring little time. All position data of all light fixtures can be detected by the position-determining unit and can be transmitted accordingly fully automatically to the controller. As a result, the manual set-up effort is clearly reduced.

The invention furthermore relates to a method for installing a plurality of light fixtures according to the preamble of claim 19. A known method according to the preamble of claim 19 for installing a plurality of light fixtures has already been described above. This method is considered very complex, because it requires a very high manual position-determining effort. The light fixtures are connected to a controller via a signal line. Preferably, each light fixture has a separate memory in which a separate identifier is written. Each light fixture can be identified, since the identifier can be transmitted via the signal line, particularly to the controller.

It is the object of the invention to simplify the known installation method. The invention achieves this object with the characteristics of claim 19.

To further validate the invention according to claim 19, the above explanations made for claims 1 to 18 are included by reference that explain the inventive principle of claim 19 in an analog fashion.

Further advantages of the invention are disclosed in the dependent claims as well as the description provided hereinafter of the illustrated embodiments illustrated in the drawings, where:

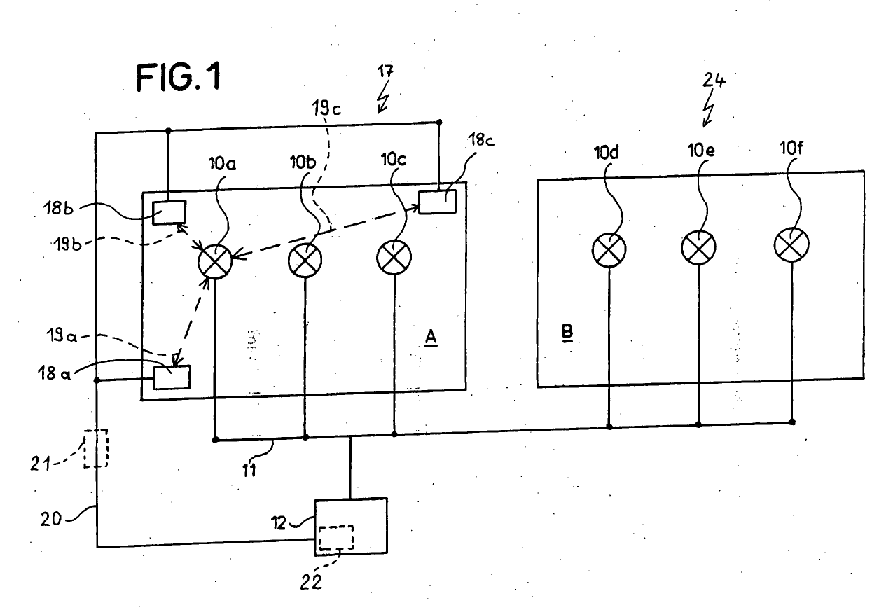

FIG. 1 is a block diagram-like, very schematic illustration of one embodiment of a lamp control system with six light fixtures according to the invention and one positioning system according to the invention for the light fixtures;

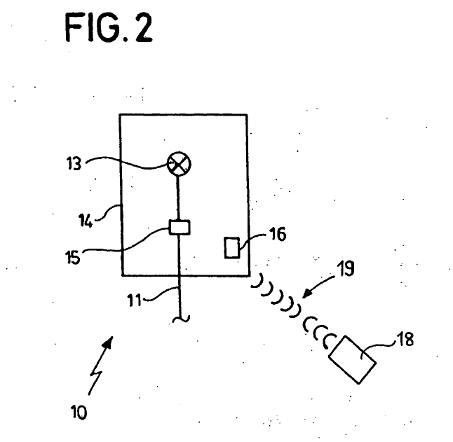

FIG. 2 is a schematic, block diagram-like individual illustration of a light fixture according to the invention; and

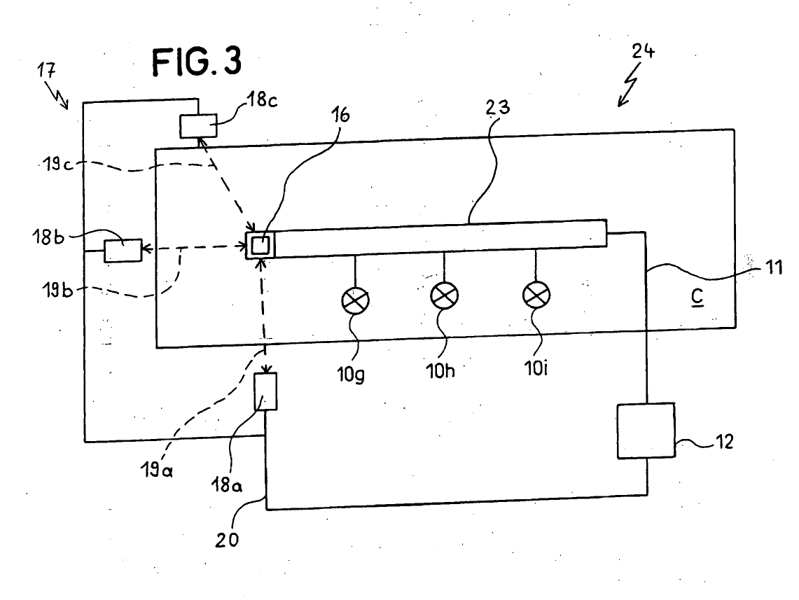

FIG. 3 is a schematic illustration comparable to the illustration according to FIG. 1 of a further embodiment of the lamp control system according to the invention with a power rail according to the invention.

The invention will be explained hereinafter by way of example with reference the description of the figures. In the description of the figures, for clarity reasons, identical or comparable or functionally equivalent parts or elements have been assigned the same reference numerals, in part with added letters.

FIG. 1 is a simplified block diagram of a first room A of a building, in which three light fixtures 10a, 10b, and 10c according to the invention are provided, and a second room B of a building, in which three light fixtures 10d, 10e, and 10f are provided.

Each light fixture, as illustrated best in FIG. 2, comprises at least one light source 13, for example a conventional bulb, optionally also several, even different or differently colored light sources. Particularly also LED modules or similar elements can be used as the light source.

Typically, each light fixture 10 also has an associated light fixture housing 14. FIG. 2 does not illustrate further elements of the light fixture that are essential for the function thereof, such as lenses, light-guiding elements, reflectors, electrical feed-lines, power supply lines, fastening devices, control gear, etc. since they are known in light-fixture construction.

According to FIG. 2, a light fixture 10 according to the invention has a memory 15 that is connected via a signal line 11 to a controller 12 that is illustrated in FIG. 1. In the memory 15 of the light fixture 10, an identifier, particularly in the form of a serial number, is provided that allows the light fixture to be identified. Typically, the identifier is written to the memory during production of the light fixture, meaning at the factory. Alternatively, it is also possible to individualize the light fixtures only after production, for example not until they arrive at the construction site.

Each light fixture 10, 10a, 10b, 10c, 10d, 10e, and 10f is connected to a separate power supply line that supplies the light fixture with operating voltage. The power supply line is not shown for the sake of clarity.

Each light fixture 10, 10a, 10b, 10c, 10d, 10e, and 10f is connected to the controller 12, preferably via a common signal line 11. The controller 12 may be, for example, a computer that can be used to run the lamp control software and that gives the user access to each individual light fixture. It is preferred if signals are exchanged via the signal 11 between the controller 12 and the individual light fixtures 10, 10a, 10b, 10c, 10d, 10e, and 10f according to the DALI protocol. However, other arbitrary suitable transmission protocols are possible as well. Finally, the signal line 11 can also be formed by a separate radio link that connects the controller 12 to the light fixtures 10, 10a, 10b, 10c, 10d, 10e, and 10f.

According to FIG. 2, the light fixture 10 according to the invention is provided with a transmitter 16. The transmitter 16 is in a position to emit signals, which is indicated in FIG. 2 by a radio link 19. The signals can be received by a transceiver 18.

The transmitter 16 can emit signals, for example, continuously. Alternatively, it is possible that the transceiver 18 emits signals to which the transmitter 16 replies, this signal response being subsequently received by the transceiver 18. The indicated arrow heads at the radio links 19a, 19b, 19c are intended to illustrate the different transmission or reception modes.

The transceiver 18 is part of a positioning device 17 that will be explained in more detail hereinafter with reference to FIG. 1.

FIG. 1 shows that in the building with the two rooms A and B three transceivers 18a, 18b, and 18c are provided as part of a position-determining unit 17. These are mutually spaced, resulting in three reference points inside the building. Each of the three transceivers 18a, 18b, and 18c corresponds to the transceiver 18 according to FIG. 2 and may receive signals emitted by the transmitter.16 of the associated light fixture 10, 10a, 10b, 10c, 10d, 10e, and 10f.

FIG. 1 indicates with a dotted line and very schematically the three radio links 19a, 19b, and 19c. Radio link 19a connects the transceiver 18a to the transmitter 16a of the associated light fixture 10a, which transmitter is not shown in FIG. 1. This means that the transceiver 18a is able to detect the signals of light fixture 10a emitted by the transmitter 16a.

At the same time, the two transceivers 18b and 18c are able to detect the signals of light fixture 10a emitted by the transmitter 16a.

Since several transceivers 18a, 18b, and 18c are provided, the positioning device 17 can clearly determine the position of the transmitter 16a of the light fixture 10a. When the position of the transmitter 16a and/or of the light fixture 10a has been clearly determined, successively the positions of the remaining light fixtures 10b, 10c, 10d, 10e, and 10f can be determined.

Position sensing is possible, for example, when imagining that the three transceivers 18a, 18b, and 18c can detect what direction the signals emitted by the transmitter 16a came from. The three radio links 19a, 19b, and 19c therefore represent three lines in space, which lines meet at an intersecting point that corresponds to the installation location of the transmitter 16a.

At the same time, it would be possible to detect the position of the transmitter 16a based on the detection of propagation differences or based on the detection of field strength.

The detected position information regarding the transmitter 16a can be processed either directly by the three transceivers 18a, 18b, and 18c or by a separate processor unit 21 that is shown with dotted lines in FIG. 1. The processor unit 21 can be connected to the three transceivers 18a, 18b, and 18c and may likewise be a part of the position-determining unit 17.

Alternatively, instead of the processor unit 21, a processor unit 22 that is shown with dotted lines in FIG. 1 may be provided directly in the controller 12 or may be associated with the controller 12. The processing power required for determining position information from the detected readings of the transceivers 18a, 18b, and 18c can be provided either in a processor unit 21 of the position-determining unit 17 or alternatively in a processor unit 22 of the controller 12. The position information is then combined in the controller.

It should be noted that the detailed method of measuring the signals, the propagation differences, the field strengths and the spatial directions will not be addressed in detail since measuring methods of this type are known extensively from the related art. For the invention, it is not important in detail in what way the position data are ultimately obtained. It is essential for the invention that a positioning system 17 can automatically detect the position of the light fixture 10a at the point of use, meaning after installation, and can transmit the position data automatically to the controller 12. This way, a manually complex and cumbersome installation can be eliminated and the assembly and installation of the lamp control system that overall has been assigned the reference numeral 24, can be automated and carried out in less time.

In the embodiment according to the invention, the three transceivers 18a, 18b, and 18c may be WLAN modules. The transmitter 16 in the respective light fixture 10, 10a, 10b, 10c, 10d, 10e, and 10f may likewise be a WLAN module. This allows the use of known technologies and commercially available components.

Alternatively, however, the transmitter 16 may also transmit radio signals with a different frequency. In particular, it is possible to locate a light fixture with a satellite-based positioning system, such as GPS or Galileo.

For the invention, it is essential that the determined position data regarding the individual light fixtures is transmitted to the controller 12. The controller 12 then relates this position information to the information received via the signal line 11.

As has been described above, a unique identifier has been written to the memory 15 that is connected to the signal line 11. This identifier can be transmitted to the controller 12 via the signal line 11 during installation of the light fixtures. Based on the individualized identifier, the controller 12 is then able to individually address the light fixture 10a. It is not important that the identifier advantageously is replaced with a shorter operating address later during operation.

The position-determining unit 17 receives from the transmitter 16a of the light fixture 10a the same identifier, since the identifier is included in the signals. The positioning system 17 therefore also receives, via the positioning or position information, information about the identifier and can transmit this identifier to the controller 12 via a connecting line 20. The controller 12 is now able to relate the position data about the light fixture 10a with a defined identifier to the information about the light fixture 10a connected to the signal line 11 with the same identifier.

It should be noted that the controller 12 is typically associated with a graphic control element (graphical user interface) that allows, for example, a display of the spatial orientation and the light fixtures located in the rooms. This way, the user can see particularly easily what light fixture is located in what room.

Later, the controller 12 can use the received position information particularly for planning complex light scenes, and the information allows convenient light planning.

As has been described above, the identifier written to the memory 15 is identical to the identifier transmitted together with the signals by the transmitter 16. Alternatively, there also may be different identifiers, however they should clearly relate to each other.

Above, an illustrated embodiment was described where the identifier of the light fixture 10a is transmitted via the associated memory 15a through the signal line 11 to the controller 12 as well as via a different transmission path, namely via the transmitter 16a and the positioning system 17 to the controller 12.

Alternatively, it may be provided that the identifier is not transmitted directly from the memory 15 via the signal line 11 to the controller 12, but that the controller receives the identifier of the light fixture 10a only via the positioning system 17 and thereafter uses this identifier to select and address the associated light fixture 10a. In this case, however, the identifier also has to be written to the memory 15a of the associated light fixture 10a.

In the following, a further illustrated embodiment of the invention according to FIG. 3 will be explained.

A power rail 23 is known with respect to the conventional structure and does not require any further explanations. The power rail 23 serves for one or more light fixtures, of which the light fixtures 10g, 10h and 10i are illustrated by way of example in FIG. 3. The power rail 23 is connected to a power supply via a power-supply line, which is not shown, and supplies the connected light fixtures 10g, 10h, and 10i with operating voltage. The power rail 23 furthermore comprises a connection for a signal line 11 that connects the power rail 23 to the controller 12.

According to the invention, the power rail 23 is provided with a transmitter 16 at the left end according to FIG. 3. The transmitter 16 may be provided, for example, on an end cap, or alternatively also on an element that serves the power supply in the conventional manner. The transmitter 16 is able to emit information in the form of signals that may be received by a position-determining unit 17 with transceivers 18a, 18b, and 18c. As in FIG. 1, the radio links have also been referenced.19a, 19b, and 19c and indicate that each transceiver 18a, 18b, and 18c may obtain, for example, information about the signal direction of the transmitted signals. The point of intersection of the lines 19a, 19b, and 19c therefore allows a clear determination of the installation position of the transmitter 16.

The transmitter 16 can transmit an identifier that corresponds, for example, to the identifier that clearly identifies the power rail 23. Alternatively, however, the transmitter 16 may also transmit an identifier of a light fixture 10g, 10h or 10i that is connected to the power rail 23. For this purpose, the transmitter 16 may be part of an electronic component or be associated thereto that is able to communicate, for example, with the light fixtures 10g, 10h, and 10i connected to the power rail 23. The transmitter 16 may, under certain circumstances, also be in a position to determine on the basis of propagation differences or similar information the relative positions of the light fixtures 10g, 10h, and 10i on the power rail 23 to the transmitter 16.

In the illustrated embodiment according to FIG. 3, the power rail 23 is only associated with one transmitter 16 at one end. In an illustrated embodiment, which is not shown, the power rail 23 is associated with two spaced-apart transmitters 16a and 16b that are provided at the opposite ends of the power rail.

FIG. 3 shows only a single power rail 23 in a room C of a building by way of example. The observer will notice that the power rail 23 can be part of a lamp control system 24 illustrated as in FIG. 1. The number of light fixtures, the number of rooms and the number of connected accessories is naturally arbitrary.

The observer furthermore can see, for the case where only a single power rail 23 is provided in room C, that it may suffice under certain circumstances to associate only one transmitter 16 with the power rail. If several power rails 23 are provided in a room or several rooms, it may optionally be recommended to associate several transmitters with the individual power rails as a function of the selected geometry and orientation of the power rail.

If only one transmitter 16 is associated with a power rail 23, it is important to ensure that a clear determination of the location or the orientation of the installed power rail is possible based on the determination of the position of this single transmitter.

A further illustrated embodiment of a lamp control system 24 according to the invention, which embodiment is not shown, has a plurality of power rails 23. This illustrated embodiment of the invention has addressable switch devices that can be used to connect or disconnect line sections of a complex signal line network 11 or for example individual power rails 23 or a group of power rails. The connection or disconnection may be carried out, for example, by disconnecting the power supply line sections of this network or by disconnecting the signal line sections of the network. Suitable switch units and the suitable method for disconnecting line sections are described in the German patent application DE 10 2006 019 143 A1 by the applicant, the content of which application is hereby incorporated in the content of the present application by reference.

The connection or disconnection of individual network branches or even individual power rails may allow a particularly efficient installation of a lamp control system 24 in conjunction with the identification of the light fixture positions. For example, a switch unit as mentioned above can be combined with a transmitter 16 described in the present application, so that the controller 12 receives position information about the installation locations of these switch units. The controller 12 may advantageously use this position information for an installation or setting-up process and thus allow very quick and efficient installation. At the same time, it can also be used to carry out regular routine controls to monitor the locations of the individual light fixtures.

FIG. 1 and FIG. 3 furthermore illustrate that it is not important where the individual transceivers 18a, 18b, and 18c of the position-determining unit 17 are mounted. They can be provided, for example, directly in the room in which the light fixtures are installed. Based on the range of the position-determining unit that depends on the signal strength and the signal frequency, for example, the position-determining unit 17 may also be provided in a different room of the building or also outside the building. If for example only exterior light fixtures are supposed to be installed, the position-determining unit can of course also be provided outside. It is essential that the position-determining unit provide spatial fixed points during installation of the light fixtures.

The configuration of the light fixture according to the invention makes it possible to determine the positions of several or all light fixtures connected to the controller 12 using a single positioning system 17. Depending on the size of the building and the range of the position-determining unit 17, however, it may be necessary to provide several position-determining units for a lamp control system 24.

Furthermore, it will be apparent to the reader that the transmitter 16 according to FIG. 2 does not necessarily have to be part of a light fixture 10, but may also be provided on an accessory for the light fixture 10, for example control gear for the light fixture. At the same time, the power rail 23 according to FIG. 3 may be an accessory for the corresponding light fixtures 10g, 10h, and 10i. The arrangement of a transmitter 16 in control gear associated with the light fixture 10 is advantageous insofar as the memory 15 illustrated according to FIG. 2, which is connected to the signal line 11, is typically also already integrated in the control gear for the light fixture. As a result, the additional expense for accommodating a transmitter in the control gear is small.

The observer will furthermore realize that the position-determining unit 17 is connected to the controller 12 via a connecting line 20 that may also be configured as a signal line.

Alternatively to the connecting line 20, also a radio connection may exist between the controller 12 and the positioning device 17.

The scope of protection of the present patent application also includes illustrated embodiments in which permanently installed transmitters are provided and receivers are provided on the individual light fixtures or on the accessories for the light fixtures or on the power rails, which devices each comprise a position-determining unit. This position-determining unit that is provided on the light fixture, may then draw conclusions about its own position from the signals received from the three transmitters. The position data could then in turn be processed by an electronic component that is mounted near the transmitter, for example in the light fixture, or alternatively by the controller. In the latter case, the data could also be transmitted to the controller via the signal line, so that the required intelligence or processing power for converting the received data for position sensing can be provided by the controller. Accordingly, compared to the embodiments illustrated in the drawings, in these embodiments a geometrically reversed configuration is provided, wherein the term “transmitter” for these examples can also be interpreted as a positioning receiver.

The method according to the invention for installing a plurality of light fixtures operates as follows:

The light fixtures are each provided at the factory with a respective memory and a respective transmitter. A respective identifier is written to the memory, and the transmitter is able to emit the identifier separately or as a triggered reply. The light fixtures are installed in their planned installation locations. Then they are connected to the controller via a signal line. The controller can now transmit, for example, initiation signals via the signal line and query all light fixtures with respect to the identifiers written to the individual memories. Subsequently, or alternatively also prior to the afore-described step of the identifier query, or also simultaneously, the position-determining unit can receive all signals emitted by the individual transmitters and transmit the corresponding position information. Upon transmission of the information, the information can be forwarded from the position-determining unit to the controller. The controller now compares the received position data with the identifiers received via the signal line and remembers these associations. It is preferred if software runs on the controller, which software carries out the installation routine nearly or completely automatically.

1. A light fixture (10, 10a, 10b, 10c, 10d, 10e, 10f, 10g, 10h, and 10i) to be attached to a building surface or part of a building surface, comprising a connection for a signal line (11) for connecting the light fixture to a controller (12) and comprising a memory (15) to which an identifier allowing the identification of the light fixture is written, which identifier can be transmitted via the signal line, characterized in that the light fixture has a transmitter (16, 16a) that can transmit signals wirelessly to a position-determining unit (17) for determining the installation location of the light fixture.

2. A light fixture (10, 10a, 10b, 10c, 10d, 10e, 10f, 10g, 10h, and 10i) to be attached to a building surface or part of a building surface, comprising a connection for a signal line (11) for connecting the light fixture to a controller (12) and comprising a memory (15) to which an identifier allowing the identification of the light fixture is written, which identifier can be transmitted via the signal line, characterized in that an accessory for the light fixture, for example control gear, provided close to the light fixture has a transmitter (16) that can transmit signals wirelessly to a position-determining unit (17) for determining the installation location of the light fixture or for determining the installation location of the accessory.

3. A power rail (23) for attaching a light fixture (10, 10a, 10b, 10c, 10d, 10e, 10f, 10g, 10h, and 10i) or several light fixtures to a building surface or part of a building surface, the power rail comprising a connection for a signal line (11) for connecting at least one light fixture to the controller (12) and at least one of the light fixtures to be connected or the power rail comprising a memory (15) to which an identifier allowing the identification of the light fixture or identification of the power rail is written, which identifier can be transmitted via the signal line, characterized in that the power rail has a transmitter (16) that can transmit signals wirelessly to a position-determining unit (17) for determining the installation location of the power rail and/or for determining the installation orientation of the power rail and/or for determining the installation location of the light fixture.

4. The light fixture or power rail according to any one of the claims 1, 2 or 3, characterized in that the position-determining unit (17) comprises at least two, preferably at least three, permanently installed transceivers (18a, 18b, and 18c) for forming reference points.

5. The light fixture or power rail according to any one of preceding claims, characterized in that the position-determining unit (17) is provided on a building surface or part of a building surface.

6. The light fixture or power rail according to any one of the claims 1 to 4, characterized in that the position-determining unit (17) is provided on a light fixture or an accessory for a light fixture, for example on control gear for a light fixture or for example on a power rail (23) for the light fixture.

7. The light fixture or power rail according to any one of the preceding claims, characterized in that the position-determining unit (17) has a receiver for the signals from the transmitter.

8. The light fixture or power rail according to claim 7, characterized in that the position-determining unit (17) has a processor unit (21) that can be used to determine the position of the transmitter and/or the position of the light fixture and/or the position of an accessory for the light fixture from the received signals.

9. The light fixture or power rail according to any one of the preceding claims, characterized in that the processor unit (21) is associated with a measuring device that can be used to measure the field strengths of the signals and/or propagation differences of the signals and/or propagation directions of the signals.

10. The light fixture or power rail according to any one of preceding claims, characterized in that the transmitter (16) and/or the position-determining unit (17) comprise WLAN modules.

11. The light fixture or power rail according to any one of the preceding claims, characterized in that the position-determining unit (17) determines the installation location of the light fixture and/or the installation location of an accessory for the light fixture.

12. The light fixture or power rail according to any one of preceding claims, characterized in that the position-determining unit (17) is connected to the controller (12).

13. The light fixture or power rail according to any one of preceding claims, characterized in that the position-determining unit (17) transmits position data about the installation location to the controller (12).

14. The light fixture or power rail according to any one of the preceding claims, characterized in that the identifier can be transmitted with the signals to the position-determining unit (17).

15. The light fixture or power rail according to claim 14, characterized in that the identifier can be transmitted from the position-determining unit (17) to the controller (12).

16. The light fixture or power rail according to any one of the preceding claims, characterized in that the identifier can be read from the memory (15) and transmitted via the signal line (11) to the controller (12).

17. The light fixture or power rail according to any one of the claims 1 to 15, characterized in that the controller (12) transmits the identifier via the signal line (11) to the light fixture (10, 10a, 10b, 10c, 10d, 10e, 10f, 10g, 10h, and 10i).

18. A system (24) for controlling and/or installing a plurality of light fixtures (10, 10a, 10b, 10c, 10d, 10e, 10f, 10g, 10h, and 10i) that are connected via a signal line (11) to a controller (12), at least one light fixture comprising a memory to which an identifier allowing the identification of the light fixture is written, which identifier can be transmitted via the signal line (11), characterized in that the light fixture is associated with a transmitter (16, 16a), from which signals can be transmitted wirelessly to a position-determining unit (17) for determining the installation location of the light fixture.

19. A method for installing a plurality of light fixtures (10, 10a, 10b, 10c, 10d, 10e, 10f, 10g, 10h, and 10i) that are connected via a signal line (11) to a controller (12), the light fixtures each comprising a memory (15) to which an identifier allowing the identification of the light fixture is written, which identifier can be transmitted via the signal line (11), characterized by the following steps:
a) wirelessly transmitting signals from a transmitter (16) of the respective light fixture to a position-determining unit (17) for determining the installation location of the light fixture,
b) transmitting information regarding the installation location of the respective light fixture from the position-determining unit to the control unit (12).

20. The method according to claim 19, characterized by the following step:
c) transmitting the identifiers of several light fixtures via the signal line to the controller.

21. The method according to claim 20, characterized by the following step:
d) associating via the controller (12) of the identifier received via the signal line with the information received from the position-determining unit (17).
